(19) United States
(12) Patent Application Publication
(10) Pub. No.: US 2011/0229847 A1
(43) Pub. Date: Sep. 22, 2011

(54) DENTAL APPLIANCE WITH PROP MEMBER AND SALIVA EJECTOR

(76) Inventor: Mark L. Worthington, Springfield, OR (US)

(21) Appl. No.: 13/048,808

(22) Filed: Mar. 15, 2011

Related U.S. Application Data
(60) Provisional application No. 61/314,758, filed on Mar. 17, 2010.

(51) Int. Cl. A61C 17/10

(52) U.S. Cl. 433/93

(57) ABSTRACT

A dental appliance includes a dental prop member and a saliva ejector member. The dental prop member has a first surface for engaging one or more maxillary teeth, a second surface for engaging one or more mandibular teeth, a posterior side, an anterior side, and a passageway extending between the posterior and anterior sides. The saliva ejector member can be received in the passageway of the dental prop member to facilitate removal of saliva and other fluids from the oral cavity.

### CROSS REFERENCE TO RELATED APPLICATION

This application claims the benefit of priority of U.S. Provisional Application No. 61/314,758, filed Mar. 17, 2010, which is herein incorporated by reference in its entirety.

### FIELD

The present disclosure relates to dental appliances and, more particular, relates to dental saliva ejectors and dental prop devices.

### BACKGROUND

Saliva ejectors are commonly used in dentistry to assist in the removal of saliva, blood, and debris from the mouth during a dental procedure. Conventional saliva ejectors are narrow tubes that can be positioned in the mouth in the vicinity of pooling saliva and other liquids. Saliva ejectors suction the excess saliva and other liquids from the mouth to maintain the mouth generally clear of liquid to improve visibility into the mouth for the dentist and to improve the comfort of the patient.

Bite blocks or dental props are commonly used in dentistry to prop open the mouth of a patient to make it easier for a dentist to access and work within the oral cavity. Conventional dental props are configured to receive the cusps of the bicuspid and molar teeth at one side of the mouth to “prop” open the mouth.

U.S. Pat. No. 5,769,635 discloses a bite block that stabilizes a saliva ejector. However, the saliva ejector bite block of U.S. Pat. No. 5,769,635 has several drawbacks. For example, the saliva ejector is stabilized with the bite block in a position where the saliva ejector tip can disadvantageously contact the tongue or cheek of the patient. Such contact reduces the ability of the saliva ejector to suction fluids from the mouth. Moreover, such contact with the tongue or cheek can be noisy and distracting to the dentist, as well as uncomfortable for the patient.

Other problems of conventional bite blocks and/or saliva ejectors, including the design of the appliance described in U.S. Pat. No. 5,769,635, include decreased access or visibility into the oral cavity due to the location and placement of the saliva ejector.

### SUMMARY

The foregoing problems are addressed by the dental appliances and methods of use disclosed herein.

In one embodiment a dental appliance comprises a dental prop member and a saliva ejector member. The dental prop member has a first surface for engaging one or more maxillary teeth, a second surface for engaging one or more mandibular teeth, a posterior side, an anterior side, and a passageway extending between the posterior and anterior sides. The saliva ejector member has an elongate hollow member and a suction tip coupled to the intraoral end of the hollow member. At least a portion of the saliva ejector member can be received within the passageway of the dental prop member and the suction tip can be positioned between the first and second surfaces of the dental prop member so that the first and second surfaces of the dental prop member at least partially overlap the suction tip. In certain embodiments, an intraoral end of the suction tip does not extend beyond a posterior side of the dental prop member by more than about 1 cm or, in another embodiment, by more than about 0.5 cm. In yet another embodiment, an intraoral end of the suction tip does not extend beyond a posterior side of the dental prop member and the first and second surfaces completely overlap the suction tip.

In certain embodiments, the saliva ejector member can be movable relative to the dental prop member to adjust the location of the suction tip relative to the first and second surfaces. In other embodiments, the passageway can include a first opening adjacent the anterior side of the dental prop member and a second opening adjacent the posterior side of the dental prop member, and the hollow member can have a profile that is smaller than the first opening and the suction tip can have a profile that is larger than the first opening. The suction tip can be positioned in the passageway so that an extraoral end of the suction tip abuts a surface surrounding the first opening. In certain embodiments, the first and second surfaces can have one or more projections extending from one or both of the first and second surfaces. In other embodiments, the first and second surfaces can taper from a first height to a second height. The ratio of the first height to the second height can range from about 1.2 to 1 and 1.04 to 1. In certain embodiments, a portion of the hollow member that extends out of the anterior side of the dental prop member can be bent at an angle of between about 90 and 180 degrees relative to a longitudinal axis of the passageway, or more preferably between about 120 and 180 degrees.

In another embodiment, a dental appliance for positioning between maxillary and mandibular teeth to hold a patient's mouth open includes a dental prop member and a saliva ejector member. The dental prop member has a first surface for engaging one or more maxillary teeth, a second surface for engaging one or more mandibular teeth, a posterior side, an anterior side, and a passageway extending between the posterior and anterior sides. The saliva ejector member has an elongate hollow member and a suction tip coupled to an intraoral end of the hollow member. The saliva ejector member is positioned in the passageway of the dental prop member so that an intraoral end of the suction tip is adjacent the posterior side of the dental prop member. The hollow member comprises a first portion that extends at least partially into the passageway and is generally aligned along a longitudinal axis of the passageway and a second portion that extends out of the anterior side of the dental prop member at an angle relative to the longitudinal axis of the passageway.

In certain embodiments, the angle of the second portion of the hollow member relative to the longitudinal axis of the passageway is between about 90 and 180 degrees. In other embodiments, the angle is between about 120 and 180 degrees. The second portion of the hollow member can be offset from the facial side of the dental prop member, preferably by at least 1 cm. The second portion of the hollow member can be sufficiently rigid to at least partially retract a cheek of the patient when the dental appliance is positioned between the maxillary and mandibular teeth. The distance between the first and second surfaces can taper from a first height to a second height. The height of the posterior side of the dental prop member can be smaller than the height of the anterior side of the dental prop member. The ratio of the first height to the second height can range from about 1.2 to 1 and 1.04 to 1.

In another embodiment, a dental appliance kit is provided. The kit can include a plurality of dental prop members and at least one saliva ejector member. The plurality of dental prop members have a first surface for engaging one or more maxillary teeth, a second surface for engaging one or more mandibular teeth, a posterior side, an anterior side, a passageway extending between the posterior and anterior sides, and an average height between the first and second surfaces. The saliva ejector member has an elongate hollow member and a suction tip coupled to an intraoral end of the hollow member. At least a portion of the saliva ejector member is receivable within the passageway of the plurality of dental prop members. The dimensions of the passageways of each of the plurality of dental prop members is substantially the same, but the average height of one or more of the plurality of dental prop members is different from the average height of another of the plurality of dental prop members.

In certain embodiments, the suction tip of the saliva ejector member is positionable between the first and second surfaces of a dental prop member so that the first and second surfaces of the dental prop member at least partially overlap the suction tip. In other embodiments, each of the plurality of dental prop members has a height defined by the first and second surfaces that tapers from a first height to a second height. The height of the posterior side of the dental prop member is smaller than the height of the anterior side of the dental prop member, and the ratio of the first height to the second height can range from about 1.2 to 1 and 1.04 to 1.

The foregoing and other features and advantages of the disclosed embodiments will become more apparent from the following detailed description, which proceeds with reference to the accompanying figures.

### BRIEF DESCRIPTION OF THE DRAWINGS

FIG. 1 illustrates a perspective view of a dental appliance that comprises a dental prop member and a saliva ejector member.

FIG. 2 illustrates a top view of the dental prop member of FIG. 1, shown without a saliva ejector member positioned in a passageway of the dental prop member.

FIG. 3A illustrates a side view of a portion of the dental appliance shown in FIG. 1, with a tip of the saliva ejector member extending only slightly beyond a tip of the dental prop member.

FIG. 3B illustrates a side view of a portion of the dental appliance shown in FIG. 1, with the saliva ejector member protected within the dental prop member.

FIG. 4 illustrates a schematic view of the dental appliance of FIG. 1 positioned in a posterior portion of a patient's mouth and shown with a portion of the saliva ejector member at least partially retracting the cheek of the patient to improve access to the oral cavity.

FIG. 5 illustrates a dental appliance 10 comprising a dental prop member 12 and a saliva ejector member 14 positioned on a left side of a patient's mouth between the patient's dental arches.

### DETAILED DESCRIPTION

Various illustrations are provided to give a more thorough understanding of the various principles of the embodiments of the present disclosure. The following description is exemplary in nature and is not intended to limit the scope, applicability, or configuration of the invention in any way. Various changes to the described embodiment may be made in the function and arrangement of the elements described herein without departing from the scope of the invention.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

Terms are used herein in accordance with their ordinary meaning, unless otherwise defined in this specification. To assist with an understanding of this disclosure, the follow explanation of terms is provided:

Anterior: towards the front of the patient.

Cusps: Pointed or rounded elevations of enamel on occlusal surfaces of cuspids and posterior teeth.

Dental arches: The permanent teeth are arranged in an upper (maxillary) dental arch and a lower (mandibular) dental arch.

Distal: Away from the midline. The distal surface of the tooth is generally the “back” surface of the tooth (farther from a frontal plane).

Extraoral: External to the oral cavity, for example at or external to the lips. An extraoral side of a member positioned within the oral cavity is the side that is closer to a location external to the oral cavity.

Facial side: The side of the teeth that are next to the cheeks and lips. The facial side includes labial surfaces (next to the lips in the anterior dental arch) and buccal surfaces (next to the check in the posterior dental arch).

Intraoral: Within the oral cavity.

Mesial: Toward the midline. The mesial surface of a tooth is generally the “front” surface of the tooth (closer to a frontal plane).

Midline: An imaginary line that extends between the central incisors in the medial plane of the body.

Occlusal surfaces: The surfaces of contact between the maxillary and mandibular teeth. The occlusal surfaces are located on the bottom face of the maxillary teeth and the top face of the mandibular teeth.

Posterior: towards the rear of the patient.

Quadrants: The permanent teeth are divided into four quadrants. These quadrants are the maxillary right quadrant, the maxillary left quadrant, the mandibular left quadrant, and the mandibular right quadrant. Each quadrant contains one of each tooth type: (1) central incisor; (2) lateral incisor; (3) cuspid (canine); (4) first bicuspid; (5) second bicuspid; (6) first molar; (7) second molar; (8) third molar (wisdom tooth).

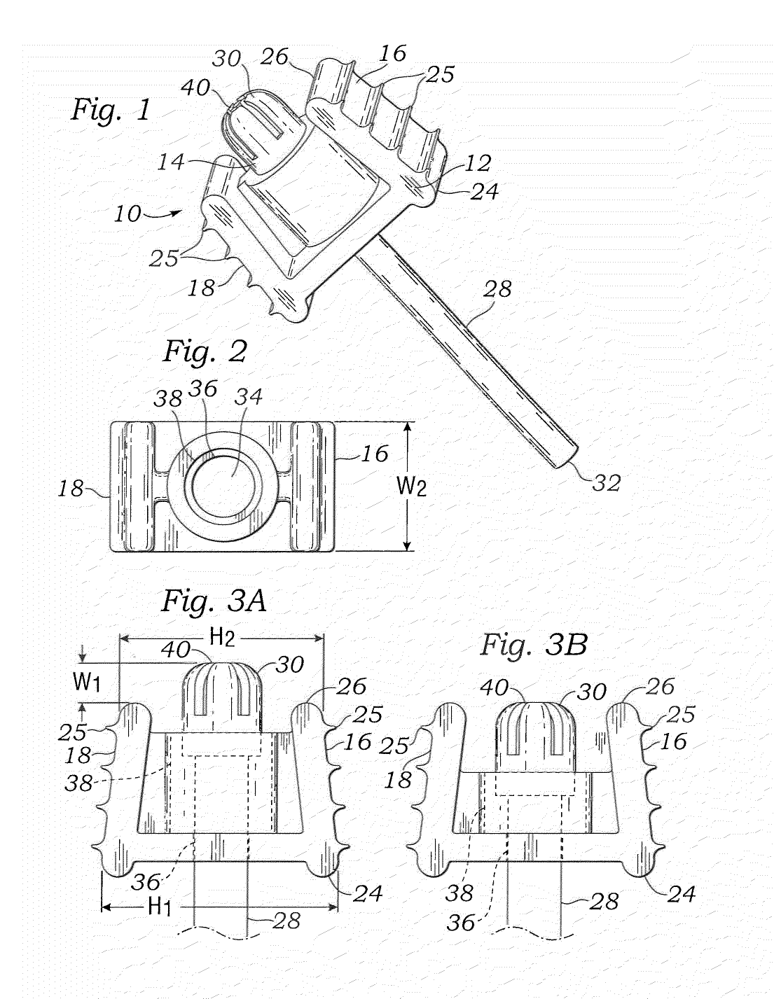

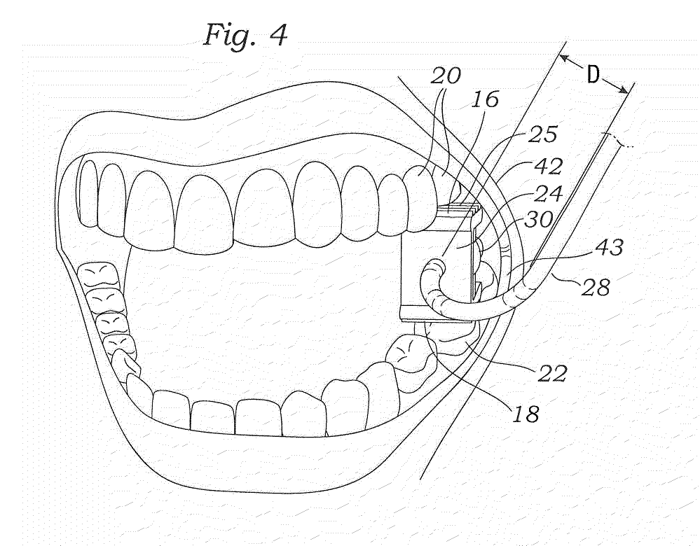

FIG. 1 illustrates a novel dental appliance 10 that comprises a dental prop member 12 and a saliva ejector member 14. Dental prop member 12 can comprise a first surface 16 and a second surface 18. When dental prop member 12 is positioned in an anterior-posterior orientation within the mouth of a patient as shown in FIG. 4, first surface 16 engages the occlusal surface of one or more maxillary teeth 20 and second surface 18 engages the occlusal surface of one or more mandibular teeth 22 to hold the mouth of the patient open a predetermined amount.

First and second surfaces 16, 18 can be parallel to one another. However, to improve comfort and ease of use of dental appliance 10, first and second surfaces 16, 18 can be formed so that they are non-parallel to one another. As best shown in FIGS. 3A and 3B, first and second surfaces 16, 18 of dental prop member 12 can taper from a first height H1 at an anterior side 24 of dental prop member 12 to a second, smaller height H2 at a posterior side 26 of dental prop member 12. When positioned in the mouth and engaged with the maxillary and mandibular teeth, dental prop member 12 extends between the dental arches with posterior side 26 facing the posterior of the mouth and anterior side 24 facing the anterior of the mouth. When a patient's mouth is open, opposing maxillary and mandibular teeth are generally non-parallel and opposing teeth in the back (posterior) of the mouth are closer together than opposing teeth closer to the front (anterior) of the mouth. The tapered configuration of dental prop member 12 makes it easier to position dental prop member 12 between the dental arches in the posterior of the mouth, and also improves patient comfort when the patient's teeth engage the non-parallel surfaces of dental prop member 12.

As shown in FIGS. 1 and 4, to reduce movement of dental prop member 12 when engaged with the maxillary and mandibular teeth, ridges or projections 25 can extend from one or both of first and second surfaces 16, 18 of dental prop member 12. Any number of ridges or projections 25 can be provided on first and second surfaces 16, 18. Desirably, the spacing between the ridges or projections 25 is sufficient to capture or otherwise frictionally engage the cusps of the teeth that are engaged with first and second surfaces 16, 18 of dental prop member 12.

Accordingly, the positioning of dental prop member 12 of dental appliance 10 in a posterior area of the dental arches allows a patient's mouth to be opened as much as possible to improve access to the oral cavity. In addition, as discussed in more detail below, a saliva ejector can be positioned at the posterior side of dental prop member 12 where liquid and debris tends to pool in the mouth.

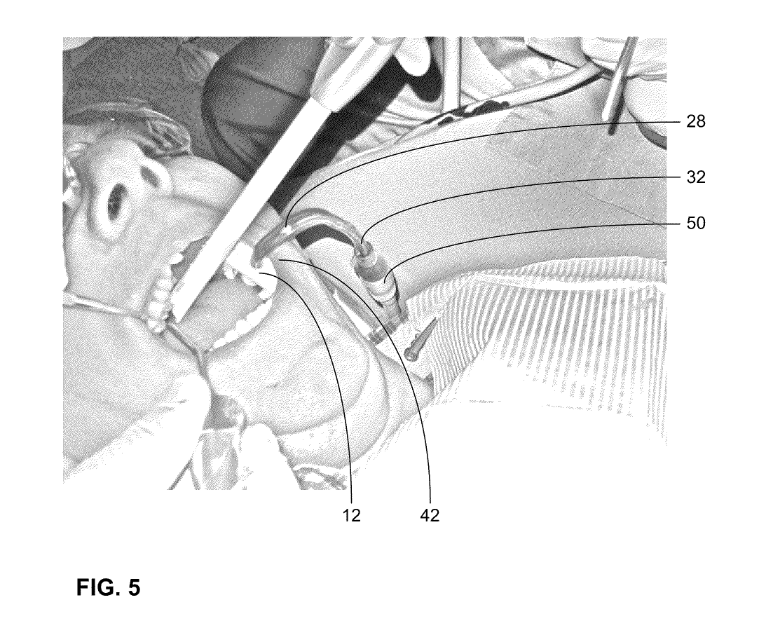

Saliva ejector member 14 can comprise an elongate hollow member 28 with a suction tip 30 coupled to an intraoral end of hollow member 28. At one end of suction tip 30, a plurality of openings are provided through which liquid (e.g., saliva, blood, etc.) and other debris in the oral cavity can be pulled into suction tip 30 and expelled through hollow member 28 to a suction device (FIG. 5) that is coupled to an extraoral end 32 of hollow member 28. As shown in FIG. 1, suction tip 30 can be formed of a diameter or width (if non-circular) that is larger than the diameter or width of hollow member 28.

Saliva ejector member 14 can be moveable relative to dental prop member 12. For example, hollow member 28 can be sized so that it can be slidably received within a passageway 34 that extends the length of dental prop member 12. Hollow member 28 preferably has a profile that causes hollow member 28 to fit snugly within passageway 34 so that hollow member 28 is generally held in position relative to dental prop member 12 unless a force is applied to hollow member 28 or dental prop member 12 along the longitudinal direction of an axis of passageway 34. The length of hollow member 28 is sufficient to extend from a desired placement of the intraoral end to a desired placement of the extraoral end for coupling to a suction device that supplies negative pressure for removing the liquid or debris from the mouth.

FIG. 2 illustrates a top view of dental prop member 12 with saliva ejector member 14 removed. Passageway 34 can be defined, at least in part, at the anterior side 24 of dental prop member 12 by a first opening 36 and at the posterior side 26 of dental prop member 12 by a second opening 38. First opening 36 can be smaller than the diameter or width of suction tip 30 but larger than the diameter or width of hollow member 28. Accordingly, extraoral end 32 of hollow member 28 can be inserted through passageway 34 (i.e., through the first and second openings 36, 38) from the posterior side 26 to the anterior side 24 of dental prop member 12. Because first opening 36 is smaller than diameter or width of suction tip 30, suction tip 30 is restricted from being pulled or pushed through dental prop 12 from posterior side 26 to anterior side 24 by engagement or contact with the surface surrounding first opening 36. If desired, the location of first opening 36 and/or the length of suction tip 30 can be configured so that when suction tip 30 contacts or abuts the surface surrounding first opening 36, suction tip 30 is in a desired position relative to dental prop member 12. Thus, a dentist can easily position saliva ejector member 14 within dental prop member 12 by pushing hollow member 28 of saliva ejector member 14 into passageway 34 until suction tip 30 engages or contacts the surface surrounding first opening 36.

Because saliva ejection member 14 can be movable relative to dental prop member 12, the relative positions of the saliva ejection member 14 and dental prop member 12 can be adjusted. Thus, for example, saliva ejector member 14 can be completely removed from dental prop member 12 and dental prop member 12 can be used without the saliva ejector member 14 to prop open a patient's mouth. In this instance, if desired, saliva ejector member 14 or another saliva ejector can be used separately from the dental prop member to remove fluid from the patient's oral cavity.

Saliva ejector member 14 can also be adjusted within dental prop member 12 to vary the location of suction tip 30 relative to dental prop member 12. For example, as discussed in more detail below, saliva ejector member 14 can be adjusted between positions where suction tip 30 extends beyond posterior side 26 of dental prop member 12 (FIG. 3A) and positions where suction tip 30 is entirely contained or protected within dental prop member 12 (FIG. 3B). Preferably, suction tip 30 is positioned between first and second surfaces 16, 18 of dental prop member 12 so that a posterior side or end of first and second surfaces 16, 18 of dental prop member 12 at least partially overlap a portion of the suction tip 30.

In operation, suction tip 30 is preferably restricted from contacting the tongue or cheek of a patient by positioning the intraoral end 40 of suction tip 30 so that intraoral end 40 does not extend far beyond posterior side 26 of dental prop member 12. As shown in FIG. 3A, intraoral end 40 of suction tip 30 preferably extends from posterior side 26 of dental prop member 12 by an amount W1 that is less than about 1 cm. More preferably, the amount W1 that intraoral end 40 of suction tip 30 extends from posterior side 26 of dental prop member 12 is less than about 0.5 cm. By reducing the amount of extension to about 1 cm or less, or more preferably about 0.5 cm or less, the likelihood that suction tip 30 will contact a surface inside the mouth of the patient (e.g., a portion of the cheek or tongue) can be greatly reduced. By reducing the likelihood that suction tip 30 will contact such intraoral surfaces, the effectiveness of the suctioning action of saliva ejector member 14 can be improved. In addition, the distracting noises and discomfort of the patient associated with contact between suction tip 30 and such intraoral surfaces is also avoided or reduced.

Even more preferably, as shown in FIG. 3B, suction tip 30 can be positioned so that intraoral end 40 does not extend beyond posterior side 26 of dental prop member 12. In this configuration, suction tip 30 is protected within the body of dental prop member 12 by first and second surfaces 16, 18, which substantially cover or enclose the suction tip 30 from above and below. By protecting suction tip 30 as shown in FIG. 3B, the likelihood that suction tip 30 will contact a cheek or tongue of the patient while performing a suctioning action is even further reduced and the effectiveness, convenience, and comfort of the dental appliance can be even further improved.

FIG. 4 illustrates dental appliance 10 positioned within the mouth of a patient so that first and second surfaces 16, 18 are engaged with one or more maxillary and mandibular teeth 20, 22. Although FIG. 4 illustrates dental appliance 10 positioned between molar teeth of the left maxillary and mandibular quadrants, by rotating dental appliance 10 by about 180 degrees it can be positioned between molar teeth of the right maxillary and mandibular quadrants. As shown in FIG. 4, dental prop member 12 can be positioned in a posterior portion of the mouth so that dental prop member 12 engages, for example, the molars in the rear of the mouth. By positioning dental prop member 12 in the rear of the mouth, dental prop member 12 remains substantially out of the way of a dentist during a dental procedure and provides the dentist with relatively unimpeded access to the oral cavity.

Hollow member 28 can be formed of a flexible material so that it can flex and conform to a desired shape. In a preferred embodiment shown in FIG. 4, hollow member 28 can be bent or shaped at an angle between about 90 degrees and 180 degrees, and more preferably between about 120 degrees and 180 degrees, to allow hollow member 28 to extend out of anterior side 24 of dental prop member 12 and around at least a portion of the patient's cheek 42. FIG. 4 illustrates hollow member 28 extending out of the anterior side 24 and bending about 180 degrees relative to a longitudinal axis of passageway 34 of dental prop member 12 so that hollow member 28 extends out of and away from the oral cavity.

By adjusting the angle that hollow member 28 is bent or shaped, the portion of hollow member 28 that extends out of anterior side 24 of dental prop member 12 can function to at least partially retract the patient's cheek 42, which improves the dentist's access to and/or view into the oral cavity. For example, as shown in FIG. 4, visibility and access into the oral cavity is improved by positioning the bent portion of hollow member 28 so that it engages and pushes against a portion of the mouth opening (e.g., patient's lips 43) to at least partially retract the patient's cheek 42. The view and access into the oral cavity is further improved because hollow member 28 is positioned on the anterior side of dental prop member 12 and generally extends outside the main area of the oral cavity. Moreover, because hollow member 28 extends generally parallel to the occlusal surface along the patient's cheek, dental prop member 12 can be positioned in a posterior position in the mouth without substantially interfering with the access provided by dental prop member 12.

As shown in FIG. 4, the bent portion of hollow member 28 can be offset by a distance D from the anterior side 24 of dental prop member 12. Distance D is preferably about 0.5 cm or more, or more preferably about 1.0 cm or more, so that hollow member 28 can extend out of the oral cavity. Although flexible enough to be bent, hollow member 28 is preferably of sufficient rigidity to resist collapse or further bending upon application of the anteriorly-directed force applied by the mouth opening when dental appliance 10 is positioned between the dental arches. If desired, a dentist or dental assistant can apply a force along hollow member 28 from the extraoral end to further retract cheek 42 to further improve access to the oral cavity.

FIG. 5 illustrates dental appliance 10 positioned between the patient's dental arches of the left side of a patient's mouth to provide relatively unimpeded access to the oral cavity. Dental appliance 10 comprises dental prop member 12 and saliva ejector member 14. Hollow member 28 of saliva ejector member 14 is bent approximately 180 degrees as it extends along the occlusal surface of the patient's teeth and out of the oral cavity to engage with a suction device 50 at its extraoral end 32. The patient's cheek is at least partially retracted by contact with hollow member 28. As shown in FIG. 5, the improved access to the oral cavity provided by dental appliance 10 allows a dentist to easily view, access, and insert various additional dental instruments into the oral cavity.

In a preferred embodiment, a kit can be provided that includes a plurality of dental prop members 12 of different sizes. Desirably, the kit comprises at least two different size dental prop members, and more desirably includes more than two different size dental prop members. For example, each of the dental prop members can have an average height defined by the average distance between the first and second surfaces of the dental prop member. These average heights can vary between about 2 cm and 3 cm. For example, a first dental prop member can have an average height of about 2.2 cm, a second dental prop member can have an average height of about 2.4 cm, a third can have an average height of about 2.6 cm, and a fourth can have an average height of about 2.8 cm.

The various size dental prop members 12 allow a dentist to select a dental prop member 12 of a certain size based on the procedure that is to be performed (e.g., the extent to which the mouth must be propped open) and/or based on the size of the patient's mouth. By selecting the size of the dental prop member 12, the patient's mouth can be propped open to a size required by the dentist and/or to a size that is most comfortable for the patient. Preferably, each of the different size dental prop members 12 comprise a passageway 34 that is of the same general dimensions. In this manner, the different size dental prop members 12 can use the same size saliva ejectors 14, thereby reducing the need for multiple size saliva ejectors 14.

As described above, dental prop member 12 can taper from a first height H1 at an anterior side 24 of dental prop member 12 to a second, smaller height H2 at a posterior side 26 of dental prop member 12. The ratio of first height H1 to second height H2 is desirably between about 1.2 to 1 and 1.04 to 1. If the various dental prop members included in the kit are tapered as described herein, they desirably have tapered dimensions that fall into the ratio range described above. For example, the kit can comprise dental prop members of a first size that has a height H1 of about 3.0 cm and a height H2 of about 2.7 cm, dental prop members of a second size that has a height H1 of about 2.8 cm and a height H2 of about 2.5 cm, dental prop members of a third size that has a height H1 of about 2.6 cm and a height H2 of about 2.3 cm, and dental prop members of a fourth size that has a height H1 of about 2.4 cm and a height H2 of about 2.1.

Because dental prop member 12 is positioned in an anterior-posterior manner as shown in FIG. 4, a width W2 (FIG. 2) of dental prop member 12 can be relatively small. In a preferred embodiment, the width W2 of dental prop member 12 is between about 1 and 2 cm and, more preferably about 1.5 cm. Such a width is generally sufficient to receive a saliva ejector in the dental prop member 12, while not significantly restricting a dentist's access to the oral cavity.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A dental appliance comprising:
a dental prop member having a first surface for engaging one or more maxillary teeth, a second surface for engaging one or more mandibular teeth, an anterior side, a posterior side, and a passageway extending between the anterior and posterior sides; and
a saliva ejector member having an elongate hollow member and a suction tip coupled to the intraoral end of the elongate hollow member, at least a portion of the saliva ejector member being received within the passageway of the dental prop member,
wherein the suction tip is positioned between the first and second surfaces of the dental prop member so that the first and second surfaces of the dental prop member at least partially overlap the suction tip.

2. The dental appliance of claim 1, wherein an intraoral end of the suction tip does not extend beyond the posterior side of the dental prop member by more than about 1 cm.

3. The dental appliance of claim 1, wherein an intraoral end of the suction tip does not extend beyond a posterior side of the dental prop member by more than about 0.5 cm.

4. The dental appliance of claim 1, wherein an intraoral end of the suction tip does not extend beyond a posterior side of the dental prop member and the first and second surfaces completely overlap the suction tip.

5. The dental appliance of claim 1, wherein the saliva ejector member is movable relative to the dental prop member to adjust the location of the suction tip relative to the first and second surfaces.

6. The dental appliance of claim 5, wherein the passageway comprises a first opening adjacent the anterior side of the dental prop member and a second opening adjacent the posterior side of the dental prop member, and
the hollow member has a profile that is smaller than the first opening and the suction tip has a profile that is larger than the first opening.

7. The dental appliance of claim 6, wherein the suction tip can be positioned in the passageway so that an extraoral end of the suction tip abuts a surface surrounding the first opening.

8. The dental appliance of claim 1, wherein the first and second surfaces comprise one or more projections extending from the first and second surfaces.

9. The dental appliance of claim 1, wherein the first and second surfaces taper from a first height to a second height.

10. The dental appliance of claim 1, wherein the ratio of the first height to the second height ranges from about 1.2 to 1 and 1.04 to 1.

11. The dental appliance of claim 1, wherein a portion of the hollow member extending out of the anterior side of the dental prop member is bent at an angle of between about 90 and 180 degrees relative to a longitudinal axis of the passageway.

12. A dental appliance for positioning between maxillary and mandibular teeth to hold a patient's mouth open, the appliance comprising:
a dental prop member having a first surface for engaging one or more maxillary teeth, a second surface for engaging one or more mandibular teeth, an anterior side, a posterior side, and a passageway extending between the anterior and posterior sides; and
a saliva ejector member having an elongate hollow member and a suction tip coupled to an intraoral end of the hollow member, the saliva ejector member being positioned in the passageway of the dental prop member so that an intraoral end of the suction tip extends out of an intraoral side of the passageway,
wherein the hollow member comprises a first portion that extends at least partially into the passageway and is generally aligned along a longitudinal axis of the passageway and a second portion that extends out of the anterior side of the dental prop member at an angle relative to the longitudinal axis of the passageway.

13. The dental appliance of claim 12, wherein the angle of the second portion of the hollow member relative to the longitudinal axis of the passageway is between about 90 and 180 degrees.

14. The dental appliance of claim 13, wherein the second portion of the hollow member is offset from a facial side of the dental prop member by at least 0.5 cm.

15. The dental appliance of claim 14, wherein the second portion of the hollow member is sufficiently rigid to at least partially retract a cheek of the patient when the dental appliance is positioned between the maxillary and mandibular teeth of the patient.

16. The dental appliance of claim 12, wherein the first and second surfaces taper from a first height to a second height, and the height of the posterior side of the dental prop member is smaller than the height of the anterior side of the dental prop member.

17. The dental appliance of claim 16, wherein the ratio of the first height to the second height ranges from about 1.2 to 1 and 1.04 to 1.

18. A dental appliance kit comprising:
a plurality of dental prop members having a first surface for engaging one or more maxillary teeth, a second surface for engaging one or more mandibular teeth, a posterior side, a anterior side, a passageway extending between the posterior and anterior sides, and an average height between the first and second surfaces; and
at least one saliva ejector member having an elongate hollow member and a suction tip coupled to an intraoral end of the hollow member, at least a portion of the saliva ejector member being receivable within the passageways of the plurality of dental prop members,
wherein the dimensions of the passageways of each of the plurality of dental prop members is substantially the same, and the average height of one or more of the plurality of dental prop members is different from the average height of another of the plurality of dental prop members.

19. The dental appliance kit of claim 18, wherein the suction tip of the at least one saliva ejector member is positionable between the first and second surfaces of the dental prop member so that the first and second surfaces of the dental prop member at least partially overlap the suction tip.

20. The dental appliance kit of claim 18, wherein each of the plurality of dental prop members has a height defined by the first and second surfaces that tapers from a first height to a second height, the height of the posterior side of the dental prop member is smaller than the height of the anterior side of the dental prop member, and the ratio of the first height to the second with ranges from about 1.2 to 1 and 1.04 to 1.

21. The dental appliance kit of claim 18, wherein the plurality of dental prop member comprise at least dental prop members of different average heights.
